(19) United States
(12) Patent Application Publication
(10) Pub. No.: US 2006/0212398 A1
(43) Pub. Date: Sep. 21, 2006

(54) Key security method and system

(75) Inventor: Lloyd Seliber, Lititz, PA (US)

Correspondence Address: Lance J. Lieberman, Esq.;Cohen, Pontani, Lieberman & Pavane, Suite 1210, 551 Fifth Avenue, New York, NY, 10176, US

(73) Assignee: Dorma Door Controls, Inc.

(21) Appl. No.: 11/384,066

(22) Filed: Mar. 17, 2006

Related U.S. Application Data
(60) Provisional application No. 60/662,591, filed on Mar. 17, 2005.

(51) Int. Cl. G06Q 99/00

(52) U.S. Cl. 705/50

(57) ABSTRACT

A method and system for securing keys in which all key blanks are assigned a unique serial number and access to uncut key blanks is restricted to authorized distributors and keycutters, through whom the current location of uncut serialized key blanks is tracked in a remotely accessible database to whom only authorized individuals have access. The database stores the access code of all uncut serialized key blanks and, when a key is cut from a serialized key, an access code is associated in the database with the cut serialized key. Duplicate copies of serialized keys can be created only upon presentation of the serialized key and the access code associated in the database with the serialized key in response to verification of the association by the database. No identifying information relating to the location of a lock operable by a particular serialized key or to an owner of the serialized key is associated in the database with the serialized key.

### CROSS-REFERENCE TO RELATED APPLICATION

This application claims domestic priority from prior-filed U.S. Provisional Patent Application Ser. No. 60/662,591, filed Mar. 17, 2005, the entire disclosure of which is incorporated by reference herein.

### FIELD OF THE INVENTION

This invention relates to a key security method and system and, more particularly, to a method and system that permits locksmiths to determine quickly if a person in possession of a key is authorized to have made a duplicate of the key, while omitting or isolating from key-identifying data information which would permit the identification of the owner or location of the lock that is operable with the key.

### BACKGROUND

One of the major sources of illegal entry into one's residence or office arises from an unauthorized person obtaining a key blank on which a key for someone else's lock may be created. With many different types of locks on the market, there are in many instances no significant measures taken to limit the distribution of key blanks. Even where keys mate with a special keyway, control of the distribution of key blanks is not typically possible or exercised. Each failure of this type increases the possibility that an unauthorized person may gain entry to one's residence or office with little or no difficulty.

It is common for locksmiths to carry key or stock blanks for many different kinds of locks, from many different manufacturers, and simply presenting a key with a request to duplicate it will generally result in the bearer of the key being able to secure a duplicate without difficulty. This system makes it easy for a legitimate person to obtain a duplicate of a key, but offers no protection to the owner of the location protected by the lock operable with the key against the unauthorized duplication of the key.

Some key manufacturers have attempted to deal with this difficulty by restricting the distribution of their key blanks to limited “authorized” locksmiths, each of whom may be so authorized as to one or more exclusive key blanks (commonly with limited geographic exclusivity), so that a duplicate key may only be made at prescribed locations. Thus, one seeking to obtain a duplicate key must present the original key at one of the limited number of authorized locksmiths, thereby raising the presenter's profile and potentially making that key holder less anonymous. While providing an additional level of security, this system has the inherent drawback that a legitimate end user might not be able to conveniently obtain a duplicate key if an authorized locksmith able to create the duplicate is not readily accessible.

In some circumstances, the legitimate owner of a lock may wish to be able to authorize an agent, such as a trusted employee or associate, to have a duplicate key made, but to limit the number of duplicates which may be made, and/or to provide that the duplicate(s) may only be made during an ensuring limited period of time. Known systems do not provide a mechanism for the issuance of such limited authorizations of the right to duplicate a key.

There is accordingly a need in the industry for a method and system of providing security for making duplicate keys by, on the one hand, providing security for the owner of a lock who wishes to have a duplicate key made, while also providing a level of convenience for the user to ensure that authorized duplicates may be made easily and conveniently without being unduly restricted to one or a limited number of locksmiths that personally know the authorized user for making the duplicates.

### SUMMARY OF THE INVENTION

The present invention relates to a method and system of securing keys which maintains a first, secure database in which information is stored linking a serialized key to the location at which the key may be used, and a second, remotely accessible database which links the serialized key to an access code that is used to authenticate the bearer of the key as one with the right to have a duplicate of that key made. The present invention isolates the two databases, so that mere possession of a serialized key, even with an access code entitling the bearer to have a duplicate key made, does not provide the bearer of the key access to any information which could lead the holder of the key to learn the identity of the owner of the location of the lock with which the key may be used.

In its broadest sense, the first database can be considered optional to the invention, and/or may simply compare a paper file maintained by, for example, the manufacturer of the locks and keys. An important advantage and benefit of the invention lies in the fact that that only an authorized source can obtain or authorize another to obtain a duplicate key for a lock whose location and, indeed, whose owner (of the key and the lock) is neither stored in the authorization database—and is in any event not associated in the database with the serialized key—nor required to be known to determine whether a new or duplicate key should be created by one having access to the restricted database and to serialized key blanks from which new keys can be cut.

The inventive method is based on a network of authorized wholesale/distributors and locksmiths, all of whom agree in writing to maintain the integrity of the system by not distributing the serialized key blanks to or cutting thereon keys for anyone other than another authorized locksmith or presenter of a secret password (access code) associated with a key to be duplicated, and who will enter into a remotely accessible central database, preferably maintained by the manufacturer of the lock and keys, all transactions relating to these serialized key blanks. Fundamental to the security of the inventive method and system is that every key blank useful in locks within the system bears a unique serial number and all transactions relating to the serialized key blanks are entered into and available to the maintainer of the database, preferably the manufacturer, who can approve or disapprove any such transactions, and to remote users of the database.

It should be understood that the method steps and systems details described herein may be performed in either one or several locations, by either one device or many devices, and that different devices may perform different steps. The order of the steps may also vary, depending by way of example on the particular embodiment and circumstances of use.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF THE PREFERRED EMBODIMENTS

The following is a description of the currently preferred embodiments of the invention, in which the various aspects of the inventive method and system are detailed individually, and then explained in context.

The Serial Numbers

Each key blank and, thereby, cut key in the system has a unique identifier assigned to it, such for example as a serial number.

The identifiers can be formed from any symbols or combination of symbols chosen by the manufacturer. Thus, for example, access codes may comprise a series of geometric forms such as squares, triangles and circles, or arrows pointing upward, downward, sideways, etc. Preferably, and for ease of use, the identifiers will be alphanumeric serial numbers, although the identifiers could be represented in bar code form which may have significant advantages in certain applications as discussed below. Nevertheless, for the purpose of description it will be assumed that the identifiers each comprise a series of alphanumeric characters.

There are of course many different kinds of keys such, for example, as mechanical (traditional) keys, electronic card keys and magnetic stripe keys. Although the method of the present invention will be described in relation to mechanical keys, it should be understood by those of ordinary skill in the art that the method can be used, or adapted for use, with any kind of key with only minimal modifications well within the knowledge and ability of those of ordinary skill.

Mechanical keys are created—typically cut—from or on key blanks, i.e., key profiles having one of a predefined set of cross-sections or profiles designed to interact with a specific shape of keyway. Cut keys are formed with cutouts to mate with an individualized set of tumblers within a lock, so that a key is suited for operation with only a single lock or, in the case of a master key, a predetermined set or group of such locks. It will be appreciated, of course, that in many applications, multiple locks may be “keyed” to work with a single unique key shape, such as where an office has multiple access doors which must all be operable with the same key, to facilitate entry without an undue number of different keys. It will also be appreciated that in many applications it is useful to provide for “master” keys that are capable of opening a plurality of differently keyed doors, as where the superintendent of a building must have a single key to open a predetermined number of differently keyed office or apartment doors. Each of these applications is well-understood in the art and, therefore, for ease of explanation but without the preferred embodiments are described in relation to an application in which each key operates one and only one lock, and each lock may be operated by a single specific key and any duplicates of that key.

As a current industry standard, most key blanks are packed and shipped in boxes of 50 (although some specialty keys are shipped in boxes of 10). In the inventive system and method, it is preferred that these boxes or other containers of key blanks themselves be numbered in the same form of code as are the key blanks, e.g. alphanumerically. By way of example, each box may bear a code which defines the prefix of the unique code of each key blank contained within that box. Thus, by way of illustration, the box code may comprise one alpha symbol and three numeric symbols such, for example, as A234. Each key blank contained in box A234 will be assigned or bear a serial number with the same prefix A234. In the same illustration, each key plank serial number will further comprise a suffix such as one of the successive numbers 01 to 50, again by way of example. Thus, in this exemplary embodiment, the first key blank in box A234 will be assigned the code A23401, and the final (fiftieth) key blank in box A234 will bear the code A23450. The code which identifies box A234 will also typically denote that all of the key blanks within that box and bearing that prefix share a common feature, namely that each has the same cross-sectional profile to enter locks having a keyway designed to mate with keys having that entry profile.

Thus, each key is identified by a unique identifier, a part of which may denote the box from which the key blank originated. This information may optionally be further coded so that boxes of blanks with identical profiles, suitable for use in locks having a particular keyway, may share a common portion of the box identifier, which can potentially prove useful in some applications by facilitating the creation of duplicate keys. In other applications, on the other hand, this commonality may be undesirable as permitting easier unauthorized duplication of keys, in which case the box-associated serial number prefix or part can be randomized and bear no relation to the keyway profile with which the key blanks may be used. The choice of the specific numbering or enumeration scheme to employ is generally deemed a matter of design choice based upon a balancing of security and convenience, a balancing within the knowledge and ability of those of ordinary skill in the art.

Network Organization

While numerous variations of distribution arrangements may be employed, for convenience of implementation and by way of preferred example it is currently preferred to rely on the existing conventional distribution network for locks and key blanks, namely wholesalers/distributors as a first tier of distribution and locksmiths as the second or retail tier of distribution. Within this common distribution model, the manufacturer through previous contacts or associations and/or with the assistance of representatives delineates a group of wholesalers/distributors who serve as an intermediate tier of distribution of key blanks. In accordance with the present invention, each wholesaler/distributor enters into a preferably written agreement with the manufacturer to not distribute any of the individually serialized key blanks to anyone other than a manufacturer-approved locksmith or a recognized large-scale end user of the serialized keys such as a school, courthouse, apartment complex, etc. that maintains its own facility to cut the serialized keys itself. Each participating wholesaler/distributor agrees to record all sales or other transfers of serialized key blanks into the manufacturer's remotely accessible database so that the manufacturer can at all times determine the current holder of each serialized key blank that remains uncut. Thus, the manufacturer enters into the database each box identifier that it ships to a distributor and associates the blanks in that box with the distributor to which the box has been shipped. When the distributors sells that box of blanks to a locksmith for example it enters that information into the database to thereby now associate the key blanks in that box with the authorized locksmith.

More particularly, each wholesaler/distributor will normally stock in its inventory a plurality of boxes of the serialized key blanks. When the wholesaler sells or distributes one or more boxes of blanks to a participating and approved locksmith, the wholesaler updates the database by associating the box numbers and, thereby all of the key blanks within each such box, with the locksmith by entering each box number and the locksmith's identifying information into a remotely accessible information repository, such as a computer database maintained by the manufacturer or a service organization appointed by the manufacturer. The manufacturer is thereby kept apprised of the current location of all boxes of recent, serialized key blanks in the system.

Locksmiths have the distinct advantage under this system and method of being able to stock these high security key blanks directly from a wholesaler/distributor without having to record the transactions, which has traditionally resulted in prior art high security key systems in significant delays in the acquisition of key blanks by an authorized locksmith.

Where the distributor instead sells a box of serialized blanks to an institutional end user, it follows essentially the same steps by entering the box number(s) sold to the end user into the remotely accessible database. In this instance, however, the system will generate a password, as discussed below, for the end user, the password being associated in the database with the serial numbers of the key blanks contained within the box(es).

Passwords

Every customer, whether a large-scale or institutional end user that cuts its own keys or an individual user or the like, either adopts or (as is preferred) is assigned an access code, such as a password, that is associated with those key blanks (for institutional users) or cut keys (for individuals) which the end user purchases. The password may be alphabetical or numerical or alphanumeric, or may be formed of a variety of symbols, as a general matter of design choice. Whether the distributor or the locksmith sells the serialized key blanks or serialized keys, as appropriate to the circumstance, to the ultimate user, the selling party enters the transaction into the database. As a general matter, it is fundamental to the invention that the remotely accessible database does not store information, associated with the serialized cut keys, that identifies the location of a lock with which a corresponding cut key is operable. Neither does the remotely accessible database store information, associated with the serialized cut keys, that identifies the owner of a lock with which a corresponding cut key is operable. This assures that even if an unauthorized individual—who by way illustrative example obtains a lost or stolen serialized key—somehow gains access to all of the information maintained in the database, that individual would nevertheless be unable to determine, from the information in the database, the location of a lock operable by that key or the identity of the owner of that key. It is permissible, although not preferred, that with respect to institutional users that purchase quantities of serialized key blanks and cut their own keys to, typically, large numbers of differently-keyed locks spread about the institutional site, the database may store information associated with the serialized key blanks that identifies the institutional site and/or the owner of that site, since that information does not tie any particular key or key blank identifier to a particular lock at some location on or about the institutional site, and neither does knowledge of the owner of or contact person at the individual site provide information useful for identifying the particular lock that is operable by that key. Despite the lack of such information in the database which is associated with the serialized key to identify the person having authorized control of the key and/or the location of a lock operable by that key, the inventive method and system advantageously enables, as further explained hereinbelow, an authorized key blank distributor or an authorized locksmith to readily determine whether a person seeking to obtain additional serialized blanks or to obtain a new duplicate key has the right to be accommodated by the distributor or locksmith. At the same time, the system maintains, for the manufacturer and for those relying on the continued security of the system as implemented through limited distribution of serialized key blanks and of the serialized keys cut therefrom, full accountability of the current status and location of all uncut blanks and reliable assurance that the authority of one seeking to duplicate a serialized key that is presented to the keycutter can be quickly and easily verified without having to confirm the identity of a particular individual by a authorized keycutter, thereby permitting the customer to freely select any authorized keycutter at any convenient location.

Information that specifically identifies, for example, one or more of the owner of a lock and the serialized keys associated with that lock and the location at which the lock is installed or used, may optionally be stored by the manufacturer of the locks and serialized keys or other party responsible for overseeing the inventive system and method. However, such important identifying information—which, in the wrong hands, could potentially undermine and effectively destroy the reliability and secure aspects and nature of the system—should be maintained in a manner separate from and untied to the remotely accessible database and, in the most preferred forms of the inventive system and method, in paper files or at least in an electronic form that is only internally accessible at the location at which the data is electronically maintained. The maintenance of such information capable of identifying the owner and/or location of locks operated by the serialized keys and associated with the serials numbers of those keys is not a part of the present invention.

The remote access to the database may be via any suitable connection as a function of the location and available communication network of one seeking access to the database. It is important that, at the very least, authorized distributors and locksmiths and other keycutters—and, as explained hereinbelow, preferably also end users of locks operable by the serialized keys—have access to the database irrespective of their location(s). Thus, as used herein the term remote access may denote access from within the same site or facility at which the database is maintained, or wired or wireless access to the database from a location at any place throughout the world via, by way of example, the internet or other remote communications network.

Sales by Locksmith to Retail Purchaser

When a locksmith sells a lock and one or more serialized keys therefor to an individual end user customer or the like, the locksmith enters information relating to the sale into the remotely accessible database. Specifically, the authorized locksmith logs into the database and identifies in the database the key blank serial numbers that have been cut for a particular lock; it will be recalled that the database already contains information identifying each of the serialized key blanks being held in the locksmith's stock or premises. An access code or password is then associated with each of the newly-cut or identified keys; although the access code can be selected by the locksmith or customer and entered into the database, it is preferred that the database—or an associated application or function—automatically generate a randomized access code for association with each of the keys. That access code is given to the end user—i.e. to the person who will thereafter maintain control of the keys and to the right to authorize duplication of the keys—and must be presented to an authorized keycuter, together with one of the keys associated with the access code, if the end use desires to obtain a new duplicate key.

In some cases, a new lock and one of a predetermined plurality of precut serialized keys for that lock will at obtained by the authorized locksmith, as for example from a distributor or from the manufacturer. In that case, the key serial numbers will already be identified in the database as being in the possession of the locksmith and, optionally, an access code may already be associated in the database with those keys; in that case, the lock and precut operating keys, as received by the locksmith, will include documentation stating the access code that has been associated with the keys, for example on a preprinted card to be presented to the end user. In that scenario it is unnecessary for the locksmith to enter into the database any information relating to the sale of the lock and keys, as neither the identity of the purchasing end user nor the intended location of the lock will be stored in the database.

In preferred forms of the inventive system and method the end user may have limited access to the remote database to permit the end user to perform a variety of tasks. The authority of an end user to access the database is verified by requiring that the end user enter the serial number of one of the end user's keys and the access code associated with that key. An authenticated end user can then, for example, selectively change the access code associated with one or more of the end user's serialized keys. Similarly, the authenticated end user can lock the end user's access code against change to assure that an unauthorized third party cannot change that access code without end user knowledge.

An authenticated end use can also obtain, by request from within the database or an associated application or operating function, a limited-use password associated with one of the end user's keys which will authorize an individual who presents that key and the associated limited-user password to obtain a duplicate copy of the key. The limited-use password may define the right to create a predetermined number of copies of the associated serialized key, and/or may require that any such copies be created within a predetermined period of time. For example, an end user busy on other matters may wish to send an agent or employee or friend to an authorized locksmith to obtain two copies of one of the end user's keys. To be certain that only the desired two copies of the key are created—and thereby assure the continued security of the user's lock and keys—the end user may request and obtain a limited-use access code that permits only two copies of the presented, associated key to be created and may further request that the access code will expire unless the two copies are created within the ensuing two hours, or by a set time. The end user can additionally have the ability to rescind the rights granted by such limited-use access codes before all permitted copies have been created and/or before expiration of the temporal restriction that the access code defines.

Duplicating A Key

When a customer comes to a participating locksmith or other keycutter seeking one or more additional keys, the keycutter cannot duplicate the key without the access code associated with the serialized key to be duplicated. In preferred forms of the invention, the keycutter also cannot duplicate a serialized key—even if the person seeking the copy can recite both the key serial number and the access code—unless the person also presents the actual key bearing that serial number, because in such preferred forms of the invention the database does not contain any information which identifies, for a particular key serial number, the cuts required to duplicate that key. Thus, when presented with the original key and the access code, the keycuter enters the key serial number and the access code into the remotely accessible database and, if the database verifies that the presented access code is indeed associated with the presented key serial number, the transaction is deemed approved and the keycutter can proceed to create a duplicate key. The keycutter then identifies in the database, from among those serialized key blanks matching the key profile and present in the keycutter's known stock, the serialize blank on which the duplicate is being created, and the end user's access code is associated in the database with the newly-cut duplicate key.

As should now be apparent, a fundamental and important feature of the inventive system and method is that information which would enable an unauthorized holder of a serialized key to determine the location of a lock operable by the key, or the owner or controller of that key, is unavailable in the remotely accessible database which is used to store identifying information used to determining whether an individual is authorized to obtain a copy of the key. Used in conjunction with the controlled restriction to access to the serialized key blanks in accordance with the invention, the ability of an unauthorized holder of a serialized key to obtain a duplicate copy of that key, or to determine the location of a lock operable with that key, is significantly reduced and for all practical purposes virtually eliminated.

The System

A system suitable for practicing the above-described method primarily comprises a database application or system that stores and variously associates the contained data as herein discussed, provides login authentication for authorized distributors, keycutters such as locksmiths, serialized key end users and other database users, provides suitable programming and/or otherwise implemented operability to carry out the operations, features and functionality variously available to different types of authorized database users, and is connected to networking and communications structure to enable local and remote access to the database by those users authorized to view and modify respective parts of the stored identifying information and system and user generated data. The precise form of and the selection of hardware and software implementing the database application and system in accordance with the invention are generally matters of design choice, and the programming required to implement its functionality as herein described and contemplated is well within the normal abilities of those reasonably skilled in the relevant arts.

Similarly, although the hardware and software by which a remotely located person authorized to use the database system gains access thereto is similarly a matter of both design choice and availability of technology, it is generally contemplated that the database be remotely available via the internet through a world wide web enabled browser that presents a graphical interface through which an authorized user can interact with the database system. Such graphical interfaces are well known and can take any convenient or otherwise appropriate form, again as matters of design choice.

While there have shown and described and pointed out fundamental novel features of the invention as applied to a preferred embodiments thereof, it will be understood that various omissions and substitutions and changes in the form and details of the methods and systems described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of controlling unauthorized access to keys useful for operating corresponding locks configured for operation with the keys, comprising the steps of:
assigning to each key blank, on which a key for operating a corresponding lock is creatable, a unique identifier exclusive to said each key blank and to the each key created on said each key blank;
assigning, to a person authorized to control access to said each key, an access code;
storing said each key identifier and said access code in a remotely-accessible database in which said each key identifier and said access code are associated so that knowledge of said access code by an individual seeking to duplicate said each key defines authorization to duplicate said each key;
authorizing a key-cutter to create a duplicate new key, from a key blank held by the key-cutter, for an authorized individual who presents to the key-cutter said each key and said access code; and
assigning to said authorized key-cutter a password for access to said database so that said key-cutter can confirm in the database authorization of the individual seeking to duplicate said each key by verifying that said access code and said each key presented by the individual are associated in the database.

2. A method of controlling unauthorized access to keys in accordance with claim 1, further comprising the steps of:
storing in said database, and associating in said database with said authorized key-cutter, the unique identifiers of all key blanks held by said key-cutter so that, when said key-cutter confirms in the database authorization of the individual seeking to duplicate said each key the database lists for the key-cutter the stored unique identifiers of the key blanks held by said key-cutter for designation by the key-cutter of a selected one of the held key blanks on which the duplicate new key is created, the identifier of the duplicate new key being thereby associated in the database with the said access code assigned to the user authorized to control access to said each key.

3. A method of controlling unauthorized access to keys in accordance with claim 2, further comprising the steps of:
supplying, to said authorized key-cutter, a predetermined plurality of key blanks each assigned one of said unique identifiers, each said unique identifier of said predetermined plurality of key blanks comprising a common prefix and a unique suffix exclusive to said each unique identifier.

4. A method of controlling unauthorized access to keys in accordance with claim 3, wherein said step of supplying further comprises supplying said predetermined plurality of key blanks in a container identified by said prefix, said prefix being unique to said container.

5. A method of controlling unauthorized access to keys in accordance with claim 1, further comprising the steps of:
imprinting said unique identifier on said each key blank.

6. A method of controlling unauthorized access to keys in accordance with claim 1, wherein said associating of said each key identifier and said access code further comprises associating with said each key identifier, in the database, only information relating to said each key so that, in the event that an unauthorized person obtains access to the database, the unauthorized person cannot learn from the database identifying information relating to the authorized person or to a location of a corresponding lock operable with said each key because the database does not contain, associated with said each key identifier, identifying information relating to the authorized person or to the location of the corresponding lock operable with said each key.

7. A method of controlling unauthorized access to keys in accordance with claim 1, further comprising the steps of:
issuing to a requester, in response to a request by the requester who has logged into said database using said each key identifier and said access code for said each key, a limited-utility access code associated in the database with said each key and that defines a right, in one who presents to the authorized keycutter said each key and said limited-utility access code, to obtain a duplicate new key corresponding to said each key, so that the authorized keycutter can confirm in the database authorization of said one seeking to duplicate said each key by verifying that said limited-utility access code presented by said one is associated in said database with said each key and thereby identifies said one as authorized to obtain a duplicate of said each key.

8. A method of controlling unauthorized access to keys in accordance with claim 7, wherein said limited-utility access code further defines at least one of a number of duplicate new keys authorized by said limited-utility access code and a defined period of time during which said limited-utility access code authorizes the presenter of said each key and said limited-utility access code to obtain at least one duplicate new key corresponding to said each key.
